(19) United States
(12) Patent Application Publication
(10) Pub. No.: US 2026/0362429 A1
(43) Pub. Date: Nov. 12, 2026

(54) PUCCH-SRI INDICATION METHOD AND APPARATUS

(71) Applicant: Beijing Xiaomi Mobile Software Co., Ltd., Beijing (CN)

(72) Inventors: Gaoming DUAN, Beijing (CN); Liangang CHI, Beijing (CN)

(73) Assignee: Beijing Xiaomi Mobile Software Co., Ltd., Beijing (CN)

(21) Appl. No.: 19/130,783

(22) PCT Filed: Nov. 18, 2022
(86) PCT No.: PCT/CN2022/132987

§ 371 Date: May 16, 2025

(51) Int. Cl. H04W 72/21; H04B 7/06

(52) U.S. Cl. CPC H04W 72/21; H04B 7/06952

(57) ABSTRACT

A method, device, and system for indicating physical uplink control channel-spatial relationship information (PUCCH-SRI). In the method, a network-side device transmits PUCCH-SRI indication information to a terminal device, where the indication information specifies a number of spatial relationship information identifiers (SRI IDs) associated with a PUCCH Resource ID and corresponding spatial relationship information (SRI). The PUCCH-SRI indication information may be conveyed via medium access control control element (MAC CE) signaling and may include one or more types of information—such as first, second, third, fourth, and fifth information—encoded in both reserved and non-reserved bits to indicate the number and order of the SRI IDs. The terminal device receives the indication information and determines a PUCCH beam based on the associated SRI. The disclosed techniques improve the flexibility and efficiency of uplink beam management in wireless communication systems.

### CROSS-REFERENCE TO RELATED APPLICATION

The present application is a U.S. National Stage of International Application No. PCT/CN2022/132987, filed on Nov. 18, 2022, the contents of which are incorporated herein by reference in their entirety.

### TECHNICAL FIELD

The present disclosure relates to the technical field of communications, and in particular, to a Physical Uplink Control Channel (PUCCH)-Spatial Relation Information (SRI) indication method and apparatus, a device, and a storage medium.

### BACKGROUND

In communication systems, with the continuous development of wireless communication, the requirement for communication capability is increasing. In order to meet the ever-increasing communication requirements, multiple-in multiple-out (MIMO) technology has emerged. Distributed MIMO can not only be applied to single-cell cellular base station systems, but also can further replace multi-cell cellular base stations and form a cell-free mobile communication system in the form of distributed Multi-User Multiple-Input Multiple-Output (MU-MIMO). In distributed MIMO, there can be multiple base stations serving the same terminal device to improve the high speed and high-capacity service requirements of the terminal device. In New Radio (NR), during joint transmission by multiple Transmission/Reception Points (TRPs), it is necessary to separately indicate the corresponding beam information for each TRP. When the beam information indication is inaccurate, it leads to inaccurate determination of PUCCH beam, thereby reducing data transmission efficiency and throughput.

### SUMMARY

The present disclosure proposes a PUCCH-SRI indication method and apparatus, a device, and a storage medium. By utilizing PUCCH-SRI indication information to indicate the number of SRI IDs associated with a PUCCH Resource ID and providing rules for indicating the number of SRI IDs, the uplink transmission capabilities of the terminal device can be enhanced and the rate and reliability of data transmission can be improved.

An embodiment of the present disclosure provides a physical uplink control channel-spatial relationship information (PUCCH-SRI) indication method, which is performed by a network-side device and includes: sending PUCCH-SRI indication information to a terminal device, where the PUCCH-SRI indication information indicates a number of spatial relationship information identifiers (SRI IDs) associated with a PUCCH Resource ID and corresponding SRI.

Another embodiment of the present disclosure provides a PUCCH-SRI indication method, which is performed by a terminal device and includes: receiving PUCCH-SRI indication information sent by a network-side device, where the PUCCH-SRI indication information indicates a number of spatial relationship information identifiers (SRI IDs) associated with a PUCCH Resource ID and corresponding SRI; and determining PUCCH-SRI according to the PUCCH-SRI indication information, where the PUCCH-SRI indicates a PUCCH beam.

A yet another embodiment of the present disclosure provides a PUCCH-SRI indication apparatus, which is arranged at a network side and includes: a sending module, configured to send PUCCH-SRI indication information to a terminal device, where the PUCCH-SRI indication information indicates a number of spatial relationship information identifiers (SRI IDs) associated with a PUCCH Resource ID and corresponding SRI.

A yet another embodiment of the present disclosure provides a PUCCH-SRI indication apparatus, which is arranged at a terminal device side and includes: a receiving module, configured to receive PUCCH-SRI indication information sent by a network-side device, where the PUCCH-SRI indication information indicates a number of spatial relationship information identifiers (SRI IDs) associated with a PUCCH Resource ID and corresponding SRI; and a determining module, configured to determine PUCCH-SRI according to the PUCCH-SRI indication information, where the PUCCH-SRI indicates a PUCCH beam.

A yet another embodiment of the present disclosure provides a network-side device, which includes a processor and a memory, where a computer program is stored in the memory, and the processor executes the computer program stored in the memory to cause the network-side device to perform the method as proposed in an aforementioned embodiment.

A yet another embodiment of the present disclosure provides a terminal device, which includes a processor and a memory, where a computer program is stored in the memory the processor executes the computer program stored in the memory to cause the terminal device to perform the method as proposed in an aforementioned embodiment.

A yet another embodiment of the present disclosure provides a communication apparatus, which includes a processor and an interface circuit; the interface circuit is configured to receive code instructions and transmit them to the processor; and the processor executes the code instructions to cause the communication apparatus to perform the method as proposed in an aforementioned embodiment.

A yet another embodiment of the present disclosure provides a non-transitory computer-readable storage medium for storing instructions which, when the instructions are executed, cause the method as proposed in an aforementioned embodiment to be implemented.

A yet another embodiment of the present disclosure provides a PUCCH-SRI indication system, including: a network-side device for performing the method as proposed in an aforementioned embodiment; and a terminal device for performing the method as proposed in another aforementioned embodiment.

To sum up, in the embodiment of the present disclosure, the PUCCH-SRI indication information is sent to the terminal device, where the PUCCH-SRI indication information indicates the number of spatial relationship information identifiers (SRI IDs) associated with the PUCCH Resource ID and the corresponding SRI. In the embodiment of the present disclosure, a PUCCH-SRI indication mechanism can be provided, which can directly indicate the number of SRI IDs associated with the PUCCH Resource ID, reducing the situation that it can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The present disclosure provides a processing method for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

### BRIEF DESCRIPTION OF DRAWINGS

The above-mentioned and/or additional aspects and advantages of the present disclosure will be apparent and easily understood from the following description of embodiments taken in conjunction with accompanying drawings.

FIG. 1 is a schematic diagram of an example of a PUCCH-SRI indication method according to an embodiment of the present disclosure.

FIG. 2 is a flowchart of a PUCCH-SRI indication method according to an embodiment of the present disclosure.

FIG. 3 is a flowchart of a PUCCH-SRI indication method according to another embodiment of the present disclosure.

FIG. 4 is a flowchart of a PUCCH-SRI indication method according to another embodiment of the present disclosure.

FIG. 5 is a schematic diagram of an example of a PUCCH-SRI indication method according to another embodiment of the present disclosure.

FIG. 6 is a flowchart of a PUCCH-SRI indication method according to another embodiment of the present disclosure.

FIG. 7 is a schematic diagram of an example of a PUCCH-SRI indication method according to another embodiment of the present disclosure.

FIG. 8 is a schematic diagram of an example of a PUCCH-SRI indication method according to another embodiment of the present disclosure.

FIG. 9 is a flowchart of a PUCCH-SRI indication method according to another embodiment of the present disclosure.

FIG. 10 is a schematic diagram of an example of a PUCCH-SRI indication method according to another embodiment of the present disclosure.

FIG. 11 is a schematic diagram of an example of a PUCCH-SRI indication method according to another embodiment of the present disclosure.

FIG. 12 is a flowchart of a PUCCH-SRI indication method according to another embodiment of the present disclosure.

FIG. 13 is a flowchart of a PUCCH-SRI indication method according to another embodiment of the present disclosure.

FIG. 14 is a flowchart of a PUCCH-SRI indication method according to another embodiment of the present disclosure.

FIG. 15 is a flowchart of a PUCCH-SRI indication method according to another embodiment of the present disclosure.

FIG. 16 is a schematic structural diagram of a PUCCH-SRI indication apparatus according to an embodiment of the present disclosure.

FIG. 17 is a schematic structural diagram of a PUCCH-SRI indication apparatus according to another embodiment of the present disclosure.

FIG. 18 is a schematic structural diagram of a PUCCH-SRI indication system according to an embodiment of the present disclosure.

FIG. 19 is a block diagram of a terminal device according to an embodiment of the present disclosure.

FIG. 20 is a block diagram of a network-side device according to an embodiment of the present disclosure.

### DETAILED DESCRIPTION

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiments of the present disclosure do not represent all implementations consistent with the embodiments of the present disclosure. Rather, they are merely examples of apparatuses and methods consistent with some aspects of embodiments of the present disclosure as detailed in the appended claims.

Terms used in embodiments of the present disclosure are only for a purpose of describing specific embodiments, and are not limiting the embodiments of the present disclosure. Singular forms of “a, said, and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, this information should not be limited to these terms. These terms are used only to distinguish the same type of information from one another. For example, without departing from the scope of the present disclosure, first information can also be named as second information, and similarly, the second information can also be named as the first information. Depending on the context, the word “in a case that” and “if” as used herein can be interpreted as “at” or “when” or “in response to determining”.

The network elements or network functions involved in the embodiments of the present disclosure can be realized by independent hardware devices or by software in the hardware devices, and this is not limited in the embodiments of the present disclosure.

With the continuous development of wireless communication requirement for communication capability is also increasing. For future application scenarios such as Augmented Reality (AR)/Virtual Reality (VR), Internet of Vehicles, and Internet of Things, ultra-high rate, ultra-low latency, and ultra-large bandwidth communications are becoming the norm. In order to meet this requirement, more and more new technologies are put forward. The multiple-in multiple-out (MIMO) technology has ushered in a new era of harnessing and utilizing spatial resources in mobile communication systems.

Distributed MIMO is developed on the basis of traditional classic MIMO technology, which expands the application scope of traditional MIMO. Distributed MIMO can not only be applied to single-cell cellular base station system, but also can further replace multi-cell cellular base stations to form a cell-free mobile communication system in the form of distributed MU-MIMO, i.e., cell free technology. Cell free can provide services for all users with the same time-frequency resources, without the traditional inter-cell frequency division, and the system resources can be dynamically scheduled in all aspects, so as to improve the flexibility of existing system resource allocation and greatly improve the utilization rate of resources.

For a terminal device, distributed MIMO technology means that there will be multiple base stations serving that terminal device at the same time, and there is no cell switching. Without the concept of cell boundary, the user experience is smoother. And with multiple Transmission/Reception Point (TRPs) serving one terminal device, the signal quality can be better guaranteed, which can meet the high speed and high-capacity service requirements of terminal device.

Furthermore, in an embodiment of the present disclosure, due to different TRPs being located in different spatial positions, there are significant differences in large-scale fading corresponding to each TRP. In New Radio (NR), during joint transmission by multiple TRPs, it is necessary to indicate the corresponding beam information for different TRPs. A downlink beam can be indicated by Transmission Configuration Indicator (TCI) state, and an uplink beam can be indicated by SRI. Specifically, up to eight PUCCH-spatial relationship information (SpatialRelationInfo) are configured for spatial relationship information addition mode list (spatialRelationInfoToAddModList) in PUCCH-configuration config.

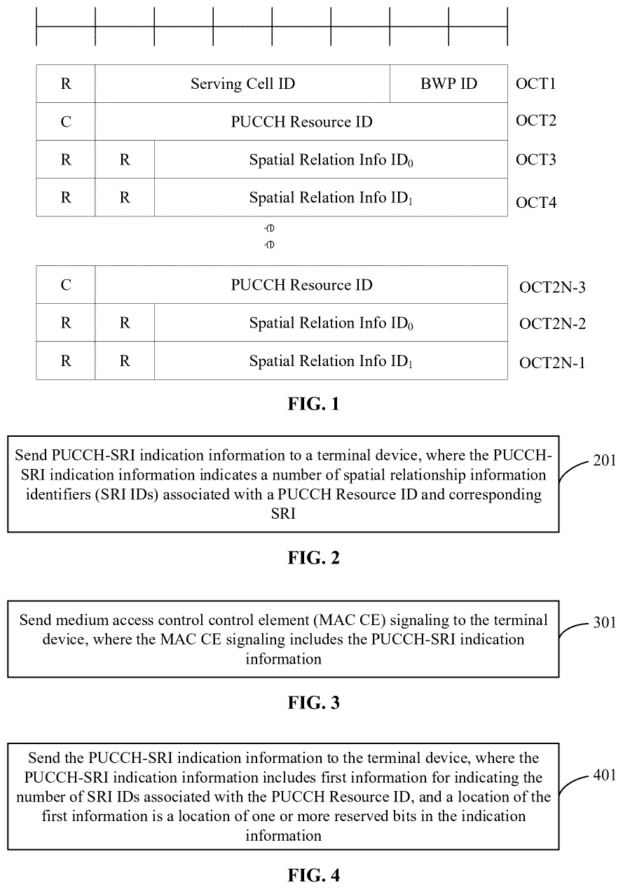

For example, in an embodiment of the present disclosure, FIG. 1 is a schematic diagram of an example of a PUCCH-SRI indication method according to an embodiment of the present disclosure. As shown in FIG. 1, a Serving Cell ID is used to indicate an identifier of a serving cell to which a medium access control (MAC) control element (CE) is applied, and a length of the Severing Cell ID field may be 5 bits. A Bandwidth Part (BWP) ID field includes an identifier (ID) corresponding to an uplink bandwidth part to which the MAC CE is applicable. PUCCH Resource ID is used to indicate a resource used for PUCCH transmission. Spatial Relation Info ID is used to determine PUCCH-SpatialRelationInfo and has a length of 6 bits. “C” bit shown in FIG. 1 is used to indicate whether there is a second one of the Spatial Relation Info IDs associated with the PUCCH Resource. “R” is a reserved bit. “OCT” stands for an octal number system. OCT1 refers to a first number in the octal number system, OCT2 refers to a second number in the octal number system, OCT3 refers to a third number in the octal number system, etc.

Moreover, in an embodiment of the present disclosure, for example, when the C bit is set to 1, it may indicate that the second one of the Spatial Relation Info IDs associated with the PUCCH Resource exists, and for example, when the C bit is set to 0, it may indicate that the second one of the Spatial Relation Info IDs associated with the PUCCH Resource does not exist.

A PUCCH-SRI indication method and apparatus, a device, and a storage medium provided by embodiments of the present disclosure are described in detail below with reference to the accompanying drawings.

FIG. 2 is a flowchart of a PUCCH-SRI indication method according to an embodiment of the present disclosure. The method is performed by a network-side device. As shown in FIG. 2, the method may include the following step.
Step 201: sending PUCCH-SRI indication information to a terminal device, where the PUCCH-SRI indication information indicates a number of spatial relationship information identifiers (SRI IDs) associated with a PUCCH Resource ID and corresponding SRI.

It should be noted that in an embodiment of the present disclosure, a terminal device may be a device that provides voice and/or data connectivity to a user. The terminal device can communicate with one or more core networks via a radio access network (RAN). The terminal device can be an Internet of Things terminal device, such as a sensor device, a mobile phone (or a “cellular” phone) and a computer with an Internet of Things terminal device. For example, it can be a fixed, portable, pocket-sized, handheld, computer-built or vehicle-mounted device. For example, a station (STA), a subscriber unit, a subscriber station, a mobile station, a mobile, a remote station, an access point, a remote terminal, an access terminal, a user terminal, or a user agent. Or, the terminal device can also be a device for an unmanned aerial vehicle. Or, the terminal device can also be a vehicle-mounted device, for example, an onboard computer with wireless communication capabilities or a wireless terminal device connected to an onboard computer. Or, the terminal device can also be a roadside device, such as a street lamp, a signal lamp or other roadside device with wireless communication function.

In an embodiment of the present disclosure, the PUCCH-SRI indication information indicates the number of spatial relationship information identifiers (SRI IDs) associated with the PUCCH Resource ID and the corresponding SRI. When the terminal device receives the PUCCH-SRI indication information, it can determine the SRI based on the indication information.

And, in an embodiment of the present disclosure, the number of SRI IDs is at least one. For example, the number of SRI IDs may be greater than two. The embodiment of the present disclosure can support more SRI indications, i.e., the number of TRPs connected to the terminal device can be increased, so that the uplink capability of the terminal device is enhanced. Each SRI may be associated with an uplink beam, i.e., a PUCCH beam, reducing a limitation in related technologies where only an existence of a second Spatial Relation Info ID associated with a PUCCH Resource could be indicated. The present disclosure can support indications for more than two uplink beams, allowing an uplink terminal device to support connections to more than two TRPs, thereby expanding the number of TRPs in uplink connections and enhancing uplink transmission capabilities. Therefore, embodiments of the present disclosure can indicate a larger number of SRI IDs, increasing the number of TRPs in uplink connections for the terminal device and enhancing uplink transmission capabilities. One of the SRI IDs can be activated via a MAC CE.

For example, in an embodiment of the present disclosure, PUCCH is used to indicate an uplink control channel that can carry various types of control information, with SRI being one type of such information. Beam information used by PUCCH may be included in SRI. Therefore, a spatial relationship of PUCCH can be determined based on the SRI, and the beam information used by PUCCH can be determined based on this spatial relationship.

In an embodiment of the present disclosure, sending the PUCCH-SRI indication information to the terminal device includes: sending medium access control control element (MAC CE) signaling to the terminal device, where the MAC CE signaling includes the PUCCH-SRI indication information.

Furthermore, in an embodiment of the present disclosure, the MAC CE signaling may be sent by the network-side device to the terminal device, where the MAC CE signaling includes the PUCCH-SRI indication information, i.e., the network-side device can send the PUCCH-SRI indication information to the terminal device.

In an embodiment of the present disclosure, the method further includes: determining, according to an extend logical channel identifier (eLCID) in a MAC subheader, the SRI carried in the MAC CE signaling.

In an embodiment of the present disclosure, sending the PUCCH-SRI indication information to the terminal device includes: sending the PUCCH-SRI indication information to the terminal device, where the PUCCH-SRI indication information includes first information for indicating the number of SRI IDs associated with the PUCCH Resource ID, and a location of the first information is a location of one or more reserved bits in the indication information.

For example, in an embodiment of the present disclosure, the first information is used to indicate the number of SRI IDs associated with the PUCCH Resource ID, and the location of the first information is the location of one or more reserved bits in the indication information. The term “first” in the first information is only used to distinguish it from other information. The first information does not specifically refer to a fixed piece of information. For example, when the number of SRI IDs associated with the PUCCH Resource ID indicated by the first information changes, the first information can also change accordingly. The term “first” in the first information is only used to distinguish it from the rest of the information and does not refer specifically to a fixed piece of information.

Further, in an embodiment of the present disclosure, the location of the first information may be, for example, the location of one or more reserved bits in the indication information. For example, when the network-side device sends the MAC CE signaling to the terminal device, where the MAC CE signaling includes the PUCCH-SRI indication information, the location of the first information may be the location of one or more reserved bits in the MAC CE signaling.

And, in an embodiment of the present disclosure, a bit length of the first information may correspond to the number of SRI IDs associated with the PUCCH Resource ID.

For example, in an embodiment of the present disclosure, the bit length of the first information is 2 bits. The first information may be, for example, “T” bit. For example, when T=00, the number of Spatial Relation Info IDs associated with the PUCCH Resource ID is 1; when T=01, the number of Spatial Relation Info IDs associated with the PUCCH Resource ID is 2; when T=10, the number of Spatial Relation Info IDs associated with the PUCCH Resource ID is 3; when T=11, the number of Spatial Relation Info IDs associated with the PUCCH Resource ID is 4.

And, in an embodiment of the present disclosure, sending the PUCCH-SRI indication information to the terminal device includes: sending the PUCCH-SRI indication information to the terminal device, where the PUCCH-SRI indication information includes second information and third information for indicating the number of SRI IDs associated with the PUCCH Resource ID, a location of the second information is a location of one or more non-reserved bits in the indication information, and a location of the third information is a location of one reserved bit in the indication information.

And, in an embodiment of the present disclosure, the second information and the third information are used together to indicate the number of SRI IDs associated with the PUCCH Resource ID. The location of the second information is the location of one or more non-reserved bits in the indication information, and the location of the third information is the location of one reserved bit in the indication information. For example, when the network-side device sends the MAC CE signaling to the terminal device, where the MAC CE signaling includes the PUCCH-SRI indication information, the location of the second information may be the location of one or more non-reserved bits in the indication information, and the location of the third information may be the location of one reserved bit in the indication information.

And, in an embodiment of the present disclosure, the term “second” in the second information is only used to distinguish it from the rest of the information and does not refer specifically to a fixed piece of information. The term “third” in the third information is only used to distinguish it from the rest of the information and does not refer specifically to a fixed piece of information. A bit length of the second information and the third information may be, for example, 2 bits.

For example, in an embodiment of the present disclosure, the second information may be, for example, “C” bit and the third information may be, for example, “T” bit. The “T” bit of the third information may be, for example, one of the reserved bits. A “C” bit in the second information is a non-reserved bit, but the meaning indicated by the “C” bit is not the meaning indicated by the “C” bit in FIG. 1. The “C” bit is only used in combination with the “T” bit to indicate the number of SRI IDs associated with the PUCCH Resource ID. For example, when CT=00, the number of Spatial Relation Info IDs associated with the PUCCH Resource ID is 1; when CT=01, the number of Spatial Relation Info IDs associated with the PUCCH Resource ID is 2; when CT=10, the number of Spatial Relation Info IDs associated with the PUCCH Resource ID is 3; when CT=11, the number of Spatial Relation Info IDs associated with the PUCCH Resource ID is 4.

For example, in an embodiment of the present disclosure, the location of the third information includes one of: the location of the third information being a location of a first reserved bit in a row where the SRI ID0 is located; or the location of the third information being a location of a second reserved bit in a row where the SRI ID0 is located.

Further, the location of the third information is not a fixed location. The location of the third information may be the location of the first reserved bit or the location of the second reserved bit in the row where the SRI ID of which SRI ID is 0 is located.

And, in an embodiment of the present disclosure, sending the PUCCH-SRI indication information to the terminal device includes: sending the PUCCH-SRI indication information to the terminal device, where the PUCCH-SRI indication information includes fourth information and fifth information, where the fourth information indicates whether there is a second one of the SRI IDs associated with the PUCCH Resource ID, and the fifth information indicates whether an SRI ID for a row corresponding to the fifth information is a last one of the SRI IDs associated with the PUCCH Resource ID.

In an embodiment of the present disclosure, different values of the fifth information can be used, for example, to indicate whether the SRI ID for the row corresponding to the fifth information is the last one of the SRI IDs associated with the PUCCH Resource ID. For example, when the fifth information takes a first value, it may indicate that the SRI ID for the row corresponding to the fifth information is the last one of the SRI IDs associated with the PUCCH Resource ID. When the fifth information takes a second value, it may indicate that the SRI ID for the row corresponding to the fifth information is not the last one of the SRI IDs associated with the PUCCH Resource ID.

Further, in an embodiment of the present disclosure, the first value and the second value are only used to indicate different values, and do not specifically refer to a fixed value. For example, the first value may be 1 and the second value may be 0. The second value may be, for example, 1, and the first value may be, for example, 0.

For example, in an embodiment of the present disclosure, the fifth information may be, for example, “T” bit. The second value may be, for example, 1, and the first value may be, for example, 0. For example, when T=0, the Spatial Relation Info ID for the row corresponding to the fifth information is not the last one of the Spatial Relation Info IDs associated with the PUCCH Resource. When T=1, the Spatial Relation Info ID for the row corresponding to the fifth information is the last one of the Spatial Relation Info IDs associated with PUCCH Resource.

For example, in an embodiment of the present disclosure, the location of the fifth information includes one of: the location of the fifth information being a location of a first reserved bit in a row where the fifth information is located; or the location of the fifth information being a location of a second reserved bit in a row where the fifth information is located.

Further, the location of the fifth information is not a fixed location. The location of the fifth information may be the location of the first reserved bit or the location of the second reserved bit in the row where the fifth information is located.

To sum up, in the embodiment of the present disclosure, the PUCCH-SRI indication information is sent to the terminal device, where the PUCCH-SRI indication information indicates the number of spatial relationship information identifiers (SRI IDs) associated with the PUCCH Resource ID and the corresponding SRI. In the embodiment of the present disclosure, a PUCCH-SRI indication mechanism can be provided, which can directly indicate the number of SRI IDs associated with the PUCCH Resource ID, reducing the situation that it can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs and can indicate the number of SRI IDs and the corresponding SRI, thereby enhancing the accuracy of PUCCH beam determination. The present disclosure provides a processing method for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

FIG. 3 is a flowchart of a PUCCH-SRI indication method according to an embodiment of the present disclosure. The method is performed by a network-side device. As shown in FIG. 3, the method may include the following step.
Step 301: sending medium access control control element (MAC CE) signaling to the terminal device, where the MAC CE signaling includes the PUCCH-SRI indication information.

In an embodiment of the present disclosure, the SRI carried in the MAC CE signaling is determined according to the eLCID in the MAC sub-header.

To sum up, in the embodiment of the present disclosure, the PUCCH-SRI indication information is sent to the terminal device, where the PUCCH-SRI indication information indicates the number of spatial relationship information identifiers (SRI IDs) associated with the PUCCH Resource ID and the corresponding SRI. In the embodiment of the present disclosure, a PUCCH-SRI indication mechanism can be provided, which can directly indicate the number of SRI IDs associated with the PUCCH Resource ID, reducing the situation that it can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The embodiment of the present disclosure specifically discloses a solution for sending PUCCH-SRI indication information to a terminal device by sending MAC CE signaling. The present disclosure provides a processing method for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

FIG. 4 is a flowchart of a PUCCH-SRI indication method according to an embodiment of the present disclosure. The method is performed by a network-side device. As shown in FIG. 4, the method may include the following step.
Step 401: sending the PUCCH-SRI indication information to the terminal device, where the PUCCH-SRI indication information includes first information for indicating the number of SRI IDs associated with the PUCCH Resource ID, and a location of the first information is a location of one or more reserved bits in the indication information.

For example, in an embodiment of the present disclosure, the term “first” in the first information does not specifically refer to a fixed piece of information. For example, when the number of SRI IDs associated with the PUCCH Resource ID indicated by the first information changes, the first information can also change accordingly. The term “first” in the first information is only used to distinguish it from the rest of the information and does not refer specifically to a fixed piece of information.

Further, in an embodiment of the present disclosure, the location of the first information may be, for example, the location of one or more reserved bits in the indication information. For example, when the network-side device sends the MAC CE signaling to the terminal device, where the MAC CE signaling includes the PUCCH-SRI indication information, the location of the first information may be the location of one or more reserved bits in the MAC CE signaling.

And, in an embodiment of the present disclosure, a bit length of the first information may correspond to the number of SRI IDs associated with the PUCCH Resource ID.

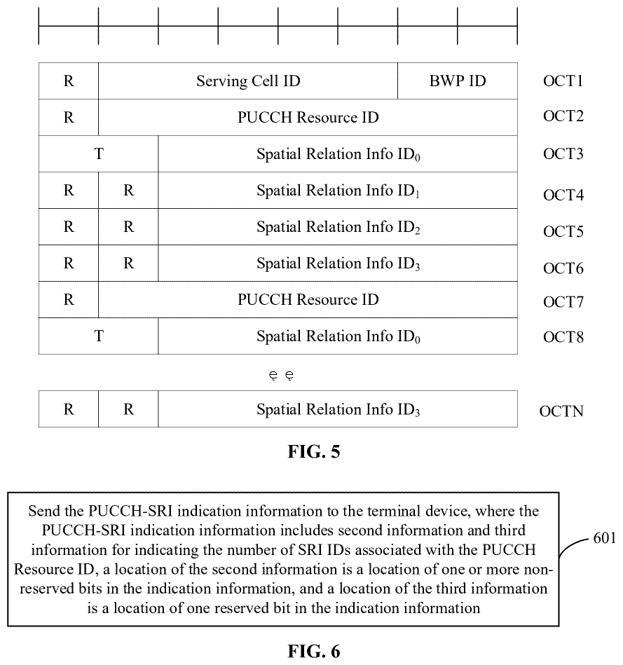

For example, in an embodiment of the present disclosure, the bit length of the first information is 2 bits. FIG. 5 is a schematic diagram of an example of a PUCCH-SRI indication method according to an embodiment of the present disclosure. As shown in FIG. 5, a Serving Cell ID is used to indicate an identifier of a serving cell to which a MAC CE is applied, and a length of the Severing Cell ID field may be 5 bits. A Bandwidth Part (BWP) ID field includes an identifier (ID) corresponding to an uplink bandwidth part to which the MAC CE is applicable, and a bit length of BWP ID is 2 bits. PUCCH Resource ID is used to indicate a resource used for PUCCH transmission, and a bit length of the PUCCH Resource ID is 7 bits. Spatial Relation Info ID is used to determine PUCCH-SpatialRelationInfo and has a length of 6 bits. “R” is a reserved bit.

For example, as shown in FIG. 5, the first information may be, for example, “T” bit. For example, when T=00, the number of Spatial Relation Info IDs associated with the PUCCH Resource ID is 1; when T=01, the number of Spatial Relation Info IDs associated with the PUCCH Resource ID is 2; when T=10, the number of Spatial Relation Info IDs associated with the PUCCH Resource ID is 3; when T=11, the number of Spatial Relation Info IDs associated with the PUCCH Resource ID is 4.

To sum up, in the embodiment of the present disclosure, the PUCCH-SRI indication information is sent to the terminal device, where the PUCCH-SRI indication information includes first information for indicating the number of SRI IDs associated with the PUCCH Resource ID, and a location of the first information is a location of one or more reserved bits in the indication information. In the embodiment of the present disclosure, a PUCCH-SRI indication mechanism can be provided, which can directly indicate the number of SRI IDs associated with the PUCCH Resource ID, reducing the situation that it can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The embodiment of the present disclosure specifically discloses a solution for sending the number of SRI IDs to a terminal device through the first information in the indication information. The present disclosure provides a processing method for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

FIG. 6 is a flowchart of a PUCCH-SRI indication method according to an embodiment of the present disclosure. The method is performed by a network-side device. As shown in FIG. 6, the method may include the following step.
Step 601: sending the PUCCH-SRI indication information to the terminal device, where the PUCCH-SRI indication information includes second information and third information for indicating the number of SRI IDs associated with the PUCCH Resource ID, a location of the second information is a location of one or more non-reserved bits in the indication information, and a location of the third information is a location of one reserved bit in the indication information.

In an embodiment of the present disclosure, the second and third information are used together to indicate the number of SRI IDs associated with the PUCCH Resource ID. The location of the second information is the location of one or more non-reserved bits in the indication information, and the location of the third information is the location of one reserved bit in the indication information. For example, when the network-side device sends the MAC CE signaling to the terminal device, where the MAC CE signaling includes the PUCCH-SRI indication information, the location of the second information may be the location of one or more non-reserved bits in the indication information, and the location of the third information may be the location of one reserved bit in the indication information.

And, in an embodiment of the present disclosure, the term “second” in the second information is only used to distinguish it from the rest of the information and does not refer specifically to a fixed piece of information. The term “third” in the third information is only used to distinguish it from the rest of the information and does not refer specifically to a fixed piece of information. A bit length of the second information and the third information may be, for example, 2 bits.

For example, in an embodiment of the present disclosure, the location of the third information includes one of: the location of the third information being a location of a first reserved bit in a row where the SRI ID0 is located; or the location of the third information being a location of a second reserved bit in a row where the SRI ID0 is located.

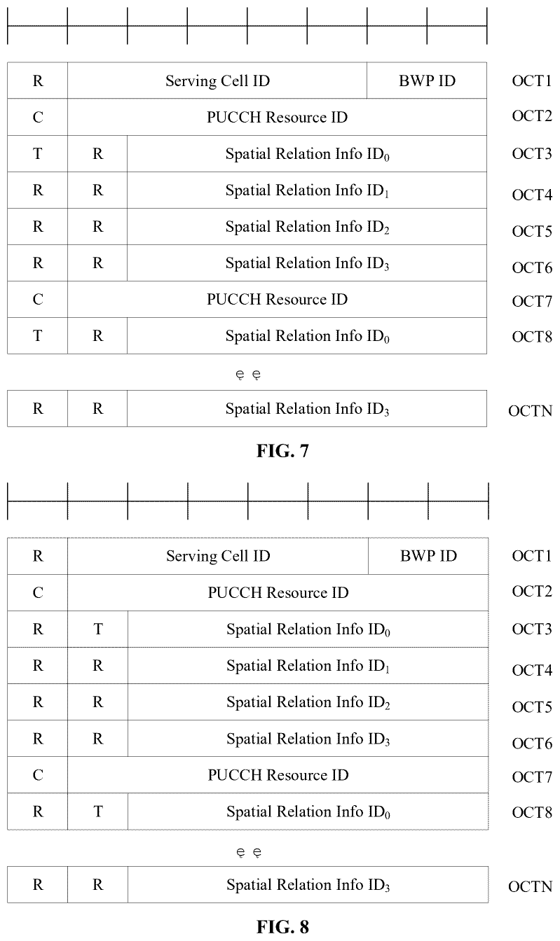

For example, in an embodiment of the present disclosure, FIG. 7 is a schematic diagram of an example of a PUCCH-SRI indication method according to an embodiment of the present disclosure. As shown in FIG. 7, the second information may be, for example, “C” bit and the third information may be, for example, “T” bit. The location of the third information is a location of a first reserved bit in a row where the SRI ID0(SRI ID0) is located.

For example, in an embodiment of the present disclosure, FIG. 8 is a schematic diagram of an example of a PUCCH-SRI indication method according to an embodiment of the present disclosure. As shown in FIG. 8, the second information may be, for example, “C” bit and the third information may be, for example, “T” bit. The location of the third information is a location of a second reserved bit in a row where the SRI ID0(SRI ID0) is located.

For example, in an embodiment of the present disclosure, in the schematic diagram shown in FIG. 7 or FIG. 8, a Serving Cell ID is used to indicate an identifier of a serving cell to which a MAC CE is applied, and a length of the Severing Cell ID field may be 5 bits. A Bandwidth Part (BWP) ID field includes an identifier (ID) corresponding to an uplink bandwidth part to which the MAC CE is applicable, and a bit length of BWP ID is 2 bits. PUCCH Resource ID is used to indicate a resource used for PUCCH transmission, and a bit length of the PUCCH Resource ID is 7 bits. Spatial Relation Info ID is used to determine PUCCH-SpatialRelationInfo and has a length of 6 bits. “R” is a reserved bit.

For example, in an embodiment of the present disclosure, as shown in FIG. 7 or FIG. 8, the second information may be, for example, “C” bit and the third information may be, for example, “T” bit. The “T” bit of the third information may be, for example, one of the reserved bits. A “C” bit in the second information is a non-reserved bit, but the meaning indicated by the “C” bit is not the meaning indicated by the “C” bit in FIG. 1. The “C” bit is only used in combination with the “T” bit to indicate the number of SRI IDs associated with the PUCCH Resource ID. For example, when CT=00, the number of Spatial Relation Info IDs associated with the PUCCH Resource ID is 1; when CT=01, the number of Spatial Relation Info IDs associated with the PUCCH Resource ID is 2; when CT=10, the number of Spatial Relation Info IDs associated with the PUCCH Resource ID is 3; when CT=11, the number of Spatial Relation Info IDs associated with the PUCCH Resource ID is 4.

To sum up, in the embodiment of the present disclosure, the PUCCH-SRI indication information is sent to the terminal device, where the PUCCH-SRI indication information includes second information and third information for indicating the number of SRI IDs associated with the PUCCH Resource ID, a location of the second information is a location of one or more non-reserved bits in the indication information, and a location of the third information is a location of one reserved bit in the indication information. In the embodiment of the present disclosure, a PUCCH-SRI indication mechanism can be provided, which can directly indicate the number of SRI IDs associated with the PUCCH Resource ID, reducing the situation that it can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The embodiment of the present disclosure specifically discloses a solution for sending the number of SRI IDs to the terminal device through the second information and the third information in the indication information. The present disclosure provides a processing method for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

FIG. 9 is a flowchart of a PUCCH-SRI indication method according to an embodiment of the present disclosure. The method is performed by a network-side device. As shown in FIG. 9, the method may include the following steps: Step 901: sending the PUCCH-SRI indication information to the terminal device, where the PUCCH-SRI indication information includes fourth information and fifth information, where the fourth information indicates whether there is a second one of the SRI IDs associated with the PUCCH Resource ID, and the fifth information indicates whether an SRI ID for a row corresponding to the fifth information is a last one of the SRI IDs associated with the PUCCH Resource ID.

In an embodiment of the present disclosure, the location of the fifth information includes one of: the location of the fifth information being a location of a first reserved bit in a row where the fifth information is located; or the location of the fifth information being a location of a second reserved bit in a row where the fifth information is located.

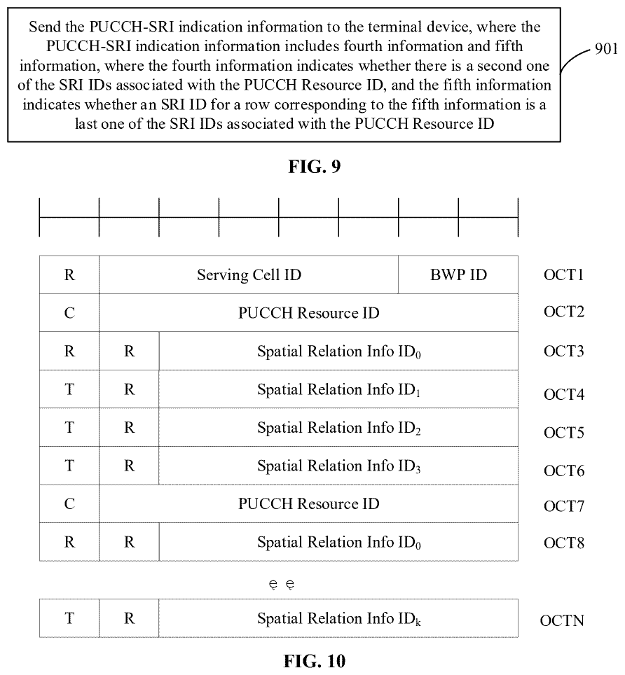

For example, in an embodiment of the present disclosure, FIG. 10 is a schematic diagram of an example of a PUCCH-SRI indication method according to an embodiment of the present disclosure. As shown in FIG. 10, the location of the fifth information is a location of a first reserved bit in a row where the fifth information is located.

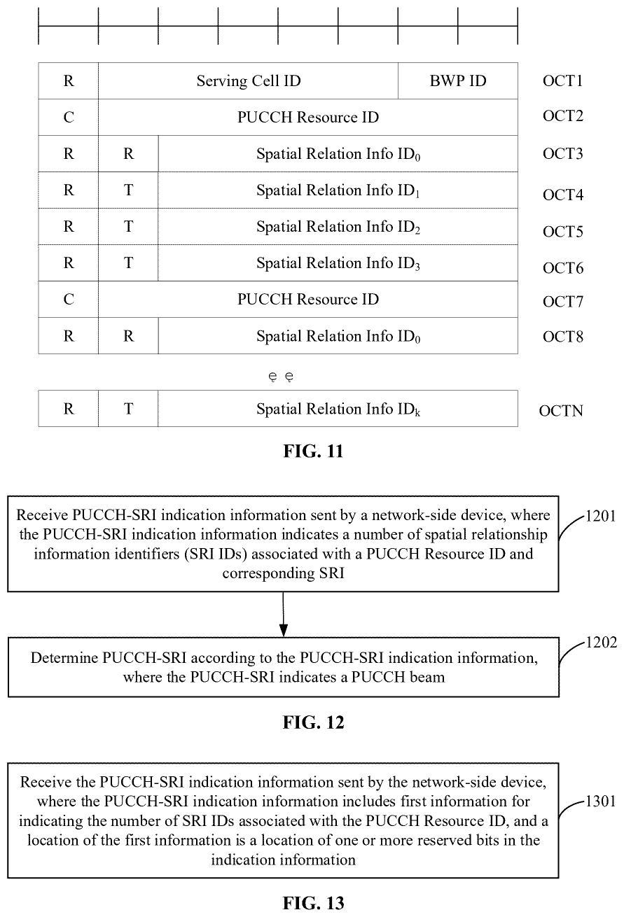

For example, in an embodiment of the present disclosure, FIG. 11 is a schematic diagram of an example of a PUCCH-SRI indication method according to an embodiment of the present disclosure. As shown in FIG. 11, the location of the fifth information is a location of a first reserved bit in a row where the fifth information is located.

For example, in an embodiment of the present disclosure, in the schematic diagram shown in FIG. 10 or FIG. 11, a Serving Cell ID is used to indicate an identifier of a serving cell to which a MAC CE is applied, and a length of the Severing Cell ID field may be 5 bits. A Bandwidth Part (BWP) ID field includes an identifier (ID) corresponding to an uplink bandwidth part to which the MAC CE is applicable, and a bit length of BWP ID is 2 bits. PUCCH Resource ID is used to indicate a resource used for PUCCH transmission, and a bit length of the PUCCH Resource ID is 7 bits. Spatial Relation Info ID is used to determine PUCCH-SpatialRelationInfo and has a length of 6 bits. “R” is a reserved bit.

In an embodiment of the present disclosure, different values of the fifth information can be used, for example, to indicate whether the SRI ID for the row corresponding to the fifth information is the last one of the SRI IDs associated with the PUCCH Resource ID. For example, when the fifth information takes a first value, it may indicate that the SRI ID for the row corresponding to the fifth information is the last one of the SRI IDs associated with the PUCCH Resource ID. When the fifth information takes a second value, it may indicate that the SRI ID for the row corresponding to the fifth information is not the last one of the SRI IDs associated with the PUCCH Resource ID.

Further, in an embodiment of the present disclosure, the first value and the second value are only used to indicate different values, and do not specifically refer to a fixed value. For example, the first value may be 1 and the second value may be 0. The second value may be, for example, 1, and the first value may be, for example, 0.

For example, in an embodiment of the present disclosure, in the schematic diagram shown in FIG. 10 or FIG. 11, the fifth information may be, for example, “T” bit. The second value may be, for example, 1, and the first value may be, for example, 0. For example, when T=0, the Spatial Relation Info ID for the row corresponding to the fifth information is not the last one of the Spatial Relation Info IDs associated with the PUCCH Resource. When T=1, the Spatial Relation Info ID for the row corresponding to the fifth information is the last one of the Spatial Relation Info IDs associated with PUCCH Resource.

To sum up, in the embodiment of the present disclosure, the PUCCH-SRI indication information is sent to the terminal device, where the PUCCH-SRI indication information includes fourth information and fifth information, where the fourth information indicates whether there is a second one of the SRI IDs associated with the PUCCH Resource ID, and the fifth information indicates whether an SRI ID for a row corresponding to the fifth information is a last one of the SRI IDs associated with the PUCCH Resource ID. In the embodiment of the present disclosure, a PUCCH-SRI indication mechanism can be provided, which can directly indicate the number of SRI IDs associated with the PUCCH Resource ID, reducing the situation that it can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The embodiment of the present disclosure specifically discloses a solution for sending the number of SRI IDs to the terminal device through the fourth information and the fifth information in the indication information. The present disclosure provides a processing method for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

FIG. 12 is a flowchart of a PUCCH-SRI indication method according to an embodiment of the present disclosure. The method is performed by a terminal device. As shown in FIG. 12, the method may include the following steps.
Step 1201: receiving PUCCH-SRI indication information sent by a network-side device, where the PUCCH-SRI indication information indicates a number of spatial relationship information identifiers (SRI IDs) associated with a PUCCH Resource ID and corresponding SRI.
Step 1202: determining PUCCH-SRI according to the PUCCH-SRI indication information, where the PUCCH-SRI indicates a PUCCH beam.

And, in an embodiment of the present disclosure, receiving the PUCCH-SRI indication information sent by the network-side device includes: receiving the PUCCH-SRI indication information sent by the network-side device, where the PUCCH-SRI indication information includes first information for indicating the number of SRI IDs associated with the PUCCH Resource ID, and a location of the first information is a location of one or more reserved bits in the indication information.

For example, in an embodiment of the present disclosure, the bit length of the first information is 2 bits.

For example, in an embodiment of the present disclosure, the term “first” in the first information does not specifically refer to a fixed piece of information. For example, when the number of SRI IDs associated with the PUCCH Resource ID indicated by the first information changes, the first information can also change accordingly. The term “first” in the first information is only used to distinguish it from the rest of the information and does not refer specifically to a fixed piece of information.

Further, in an embodiment of the present disclosure, the location of the first information may be, for example, the location of one or more reserved bits in the indication information. For example, when the network-side device sends the MAC CE signaling to the terminal device, where the MAC CE signaling includes the PUCCH-SRI indication information, the location of the first information may be the location of one or more reserved bits in the MAC CE signaling.

And, in an embodiment of the present disclosure, a bit length of the first information may correspond to the number of SRI IDs associated with the PUCCH Resource ID.

For example, in an embodiment of the present disclosure, the bit length of the first information may be, for example, 2 bits. The first information may be, for example, “T” bit. For example, when T=00, the number of Spatial Relation Info IDs associated with the PUCCH Resource ID is 1; when T=01, the number of Spatial Relation Info IDs associated with the PUCCH Resource ID is 2; when T=10, the number of Spatial Relation Info IDs associated with the PUCCH Resource ID is 3; when T=11, the number of Spatial Relation Info IDs associated with the PUCCH Resource ID is 4.

And, in an embodiment of the present disclosure, receiving the PUCCH-SRI indication information sent by the network-side device includes: receiving the PUCCH-SRI indication information sent by the network-side device, where the PUCCH-SRI indication information includes second information and third information for indicating the number of SRI IDs associated with the PUCCH Resource ID, a location of the second information is a location of one or more non-reserved bits in the indication information, and a location of the third information is a location of one reserved bit in the indication information.

In an embodiment of the present disclosure, the second and third information are used together to indicate the number of SRI IDs associated with the PUCCH Resource ID. The location of the second information is the location of one or more non-reserved bits in the indication information, and the location of the third information is the location of one reserved bit in the indication information. For example, when the network-side device sends the MAC CE signaling to the terminal device, where the MAC CE signaling includes the PUCCH-SRI indication information, the location of the second information may be the location of one or more non-reserved bits in the indication information, and the location of the third information may be the location of one reserved bit in the indication information.

And, in an embodiment of the present disclosure, the term “second” in the second information is only used to distinguish it from the rest of the information and does not refer specifically to a fixed piece of information. The term “third” in the third information is only used to distinguish it from the rest of the information and does not refer specifically to a fixed piece of information. A bit length of the second information and the third information may be, for example, 2 bits.

For example, in an embodiment of the present disclosure, the second information may be, for example, “C” bit and the third information may be, for example, “T” bit. The “T” bit of the third information may be, for example, one of the reserved bits. A “C” bit in the second information is a non-reserved bit, but the meaning indicated by the “C” bit is not the meaning indicated by the “C” bit in FIG. 1. The “C” bit is only used in combination with the “T” bit to indicate the number of SRI IDs associated with the PUCCH Resource ID. For example, when CT=00, the number of Spatial Relation Info IDs associated with the PUCCH Resource ID is 1; when CT=01, the number of Spatial Relation Info IDs associated with the PUCCH Resource ID is 2; when CT=10, the number of Spatial Relation Info IDs associated with the PUCCH Resource ID is 3; when CT=11, the number of Spatial Relation Info IDs associated with the PUCCH Resource ID is 4.

For example, in an embodiment of the present disclosure, the location of the third information includes one of:
the location of the third information being a location of a first reserved bit in a row where the SRI ID0 is located; or the location of the third information being a location of a second reserved bit in a row where the SRI ID0 is located.

Further, the location of the third information is not a fixed location. The location of the third information may be the location of the first reserved bit or the location of the second reserved bit in the row where the SRI ID of which SRI ID is 0 is located.

And, in an embodiment of the present disclosure, receiving the PUCCH-SRI indication information sent by the network-side device includes: receiving the PUCCH-SRI indication information sent by the network-side device, where the PUCCH-SRI indication information includes fourth information and fifth information, where the fourth information indicates whether there is a second one of the SRI IDs associated with the PUCCH Resource ID, and the fifth information indicates whether an SRI ID for a row corresponding to the fifth information is a last one of the SRI IDs associated with the PUCCH Resource ID.

In an embodiment of the present disclosure, different values of the fifth information can be used, for example, to indicate whether the SRI ID for the row corresponding to the fifth information is the last one of SRI IDs associated with the PUCCH Resource ID. For example, when the fifth information takes a first value, it may indicate that the SRI ID for the row corresponding to the fifth information is the last one of the SRI IDs associated with the PUCCH Resource ID. When the fifth information takes a second value, it may indicate that the SRI ID for the row corresponding to the fifth information is not the last one of the SRI IDs associated with the PUCCH Resource ID.

Further, in an embodiment of the present disclosure, the first value and the second value are only used to indicate different values, and do not specifically refer to a fixed value. For example, the first value may be 1 and the second value may be 0. The second value may be, for example, 1, and the first value may be, for example, 0.

For example, in an embodiment of the present disclosure, the fifth information may be, for example, “T” bit. The second value may be, for example, 1, and the first value may be, for example, 0. For example, when T=0, the Spatial Relation Info ID for the row corresponding to the fifth information is not the last one of the Spatial Relation Info IDs associated with the PUCCH Resource. When T=1, the Spatial Relation Info ID for the row corresponding to the fifth information is located is the last one of the Spatial Relation Info IDs associated with PUCCH Resource.

For example, in an embodiment of the present disclosure, the location of the fifth information includes one of: the location of the fifth information being a location of a first reserved bit in a row where the fifth information is located; or the location of the fifth information being a location of a second reserved bit in a row where the fifth information is located.

Further, the location of the fifth information is not a fixed location. The location of the fifth information may be the location of the first reserved bit or the location of the second reserved bit in the row where the fifth information is located.

To sum up, in the embodiment of the present disclosure, the PUCCH-SRI indication information sent by the network-side device is received, where the PUCCH-SRI indication information indicates a number of spatial relationship information identifiers (SRI IDs) associated with a PUCCH Resource ID and corresponding SRI; and the PUCCH-SRI is determined according to the PUCCH-SRI indication information, where the PUCCH-SRI indicates a PUCCH beam. In the embodiment of the present disclosure, a PUCCH-SRI indication mechanism can be provided, which can directly indicate the number of SRI IDs associated with the PUCCH Resource ID, reducing the situation that the terminal device can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The present disclosure provides a processing method for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

FIG. 13 is a flowchart of a PUCCH-SRI indication method according to an embodiment of the present disclosure. The method is performed by a terminal device. As shown in FIG. 13, the method may include the following step.
Step 1301: receiving the PUCCH-SRI indication information sent by the network-side device, where the PUCCH-SRI indication information includes first information for indicating the number of SRI IDs associated with the PUCCH Resource ID, and a location of the first information is a location of one or more reserved bits in the indication information.

For example, in an embodiment of the present disclosure, the bit length of the first information is 2 bits.

To sum up, in the embodiment of the present disclosure, the PUCCH-SRI indication information sent by the network-side device is received, where the PUCCH-SRI indication information includes first information for indicating the number of SRI IDs associated with the PUCCH Resource ID, and a location of the first information is a location of one or more reserved bits in the indication information. In the embodiment of the present disclosure, a PUCCH-SRI indication mechanism can be provided, which can directly indicate the number of SRI IDs associated with the PUCCH Resource ID, reducing the situation that the terminal device can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The embodiment of the present disclosure specifically discloses a solution for indicating the number of SRI IDs associated with a PUCCH Resource ID through the first information in the PUCCH-SRI indication information. The present disclosure provides a processing method for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

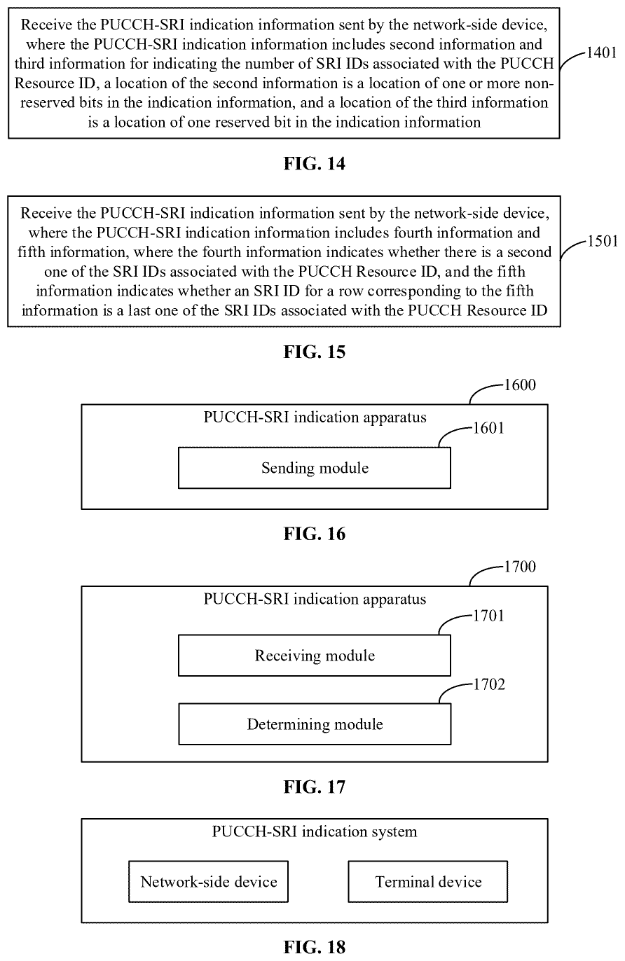

FIG. 14 is a flowchart of a PUCCH-SRI indication method according to an embodiment of the present disclosure. The method is performed by a terminal device. As shown in FIG. 14, the method may include the following step.
Step 1401: receiving the PUCCH-SRI indication information sent by the network-side device, where the PUCCH-SRI indication information includes second information and third information for indicating the number of SRI IDs associated with the PUCCH Resource ID, a location of the second information is a location of one or more non-reserved bits in the indication information, and a location of the third information is a location of one reserved bit in the indication information.

In an embodiment of the present disclosure, the location of the third information includes one of: the location of the third information being a location of a first reserved bit in a row where the SRI ID0 is located; or the location of the third information being a location of a second reserved bit in a row where the SRI ID0 is located.

To sum up, in the embodiment of the present disclosure, the PUCCH-SRI indication information sent by the network-side device is received, where the PUCCH-SRI indication information includes second information and third information for indicating the number of SRI IDs associated with the PUCCH Resource ID, a location of the second information is a location of one or more non-reserved bits in the indication information, and a location of the third information is a location of one reserved bit in the indication information. In the embodiment of the present disclosure, a PUCCH-SRI indication mechanism can be provided, which can directly indicate the number of SRI IDs associated with the PUCCH Resource ID, reducing the situation that the terminal device can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The embodiment of the present disclosure specifically discloses a solution for indicating the number of SRI IDs associated with a PUCCH Resource ID through the second information and the third information in the PUCCH-SRI indication information. The present disclosure provides a processing method for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

FIG. 15 is a flowchart of a PUCCH-SRI indication method according to an embodiment of the present disclosure. The method is performed by a terminal device. As shown in FIG. 15, the method may include the following step.
Step 1501: receiving the PUCCH-SRI indication information sent by the network-side device, where the PUCCH-SRI indication information includes fourth information and fifth information, where the fourth information indicates whether there is a second one of the SRI IDs associated with the PUCCH Resource ID, and the fifth information indicates whether an SRI ID for a row corresponding to the fifth information is a last one of the SRI IDs associated with the PUCCH Resource ID.

The location of the fifth information includes one of: the location of the fifth information being a location of a first reserved bit in a row where the fifth information is located; or the location of the fifth information being a location of a second reserved bit in a row where the fifth information is located.

To sum up, in the embodiment of the present disclosure, the PUCCH-SRI indication information sent by the network-side device is received, where the PUCCH-SRI indication information includes fourth information and fifth information, where the fourth information indicates whether there is a second one of the SRI IDs associated with the PUCCH Resource ID, and the fifth information indicates whether an SRI ID for a row corresponding to the fifth information is a last one of the SRI IDs associated with the PUCCH Resource ID. In the embodiment of the present disclosure, a PUCCH-SRI indication mechanism can be provided, which can directly indicate the number of SRI IDs associated with the PUCCH Resource ID, reducing the situation that the terminal device can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The embodiment of the present disclosure specifically discloses a solution for indicating the number of SRI IDs associated with a PUCCH Resource ID through the fourth information and the fifth information in the PUCCH-SRI indication information. The present disclosure provides a processing method for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

FIG. 16 is a schematic structural diagram of a PUCCH-SRI indication apparatus according to an embodiment of the present disclosure. As shown in FIG. 16, the apparatus 1600 may be arranged at a network side, and the apparatus 1600 may include: a sending module 1601, configured to send PUCCH-SRI indication information to a terminal device, where the PUCCH-SRI indication information indicates a number of spatial relationship information identifiers (SRI IDs) associated with a PUCCH Resource ID and corresponding SRI.

To sum up, in the embodiment of the present disclosure, the sending module is configured to send the PUCCH-SRI indication information to the terminal device, where the PUCCH-SRI indication information indicates the number of spatial relationship information identifiers (SRI IDs) associated with the PUCCH Resource ID and the corresponding SRI. In the embodiment of the present disclosure, a PUCCH-SRI indication mechanism can be provided, which can directly indicate the number of SRI IDs associated with the PUCCH Resource ID, reducing the situation that it can only indicate whether there is the second one of SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The present disclosure provides a processing apparatus for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

In some examples, in an embodiment of the present disclosure, sending the PUCCH-SRI indication information to the terminal device includes: sending medium access control control element (MAC CE) signaling to the terminal device, where the MAC CE signaling includes the PUCCH-SRI indication information.

In some examples, in an embodiment of the present disclosure, the sending module 1601 is further configured to: determine, according to an eLCID in a MAC subheader, the SRI carried in the MAC CE signaling.

In some examples, in an embodiment of the present disclosure, the sending module 1601, when sending the PUCCH-SRI indication information to the terminal device, specifically is configured to: send the PUCCH-SRI indication information to the terminal device, where the PUCCH-SRI indication information includes first information for indicating the number of SRI IDs associated with the PUCCH Resource ID, and a location of the first information is a location of one or more reserved bits in the indication information.

In some examples, in an embodiment of the present disclosure, a bit length of the first information is 2 bits.

In some examples, in an embodiment of the present disclosure, the sending module 1601, when sending the PUCCH-SRI indication information to the terminal device, specifically is configured to: send the PUCCH-SRI indication information to the terminal device, where the PUCCH-SRI indication information includes second information and third information for indicating the number of SRI IDs associated with the PUCCH Resource ID, a location of the second information is a location of one or more non-reserved bits in the indication information, and a location of the third information is a location of one reserved bit in the indication information.

In some examples, in an embodiment of the present disclosure, the location of the third information includes one of: the location of the third information being a location of a first reserved bit in a row where the SRI ID0 is located; or the location of the third information being a location of a second reserved bit in a row where the SRI ID0 is located.

In some examples, in an embodiment of the present disclosure, the sending module 1601, when sending the PUCCH-SRI indication information to the terminal device, specifically is configured to: send the PUCCH-SRI indication information to the terminal device, where the PUCCH-SRI indication information includes fourth information and fifth information, where the fourth information indicates whether there is a second one of the SRI IDs associated with the PUCCH Resource ID, and the fifth information indicates whether an SRI ID for a row corresponding to the fifth information is a last one of the SRI IDs associated with the PUCCH Resource ID.

In some examples, in an embodiment of the present disclosure, the location of the fifth information includes one of: the location of the fifth information being a location of a first reserved bit in a row where the fifth information is located; or the location of the fifth information being a location of a second reserved bit in a row where the fifth information is located.

FIG. 17 is a schematic structural diagram of a PUCCH-SRI indication apparatus according to an embodiment of the present disclosure. As shown in FIG. 17, the apparatus 1700 may be arranged at a terminal device side, and the apparatus 1700 may include: a receiving module 1701, configured to receive PUCCH-SRI indication information sent by a network-side device, where the PUCCH-SRI indication information indicates a number of spatial relationship information identifiers (SRI IDs) associated with a PUCCH Resource ID and corresponding SRI; and a determining module 1702, configured to determine PUCCH-SRI according to the PUCCH-SRI indication information, where the PUCCH-SRI indicates a PUCCH beam.

To sum up, in the embodiment of the present disclosure, the receiving module is configured to receive the PUCCH-SRI indication information sent by the network-side device, where the PUCCH-SRI indication information indicates a number of spatial relationship information identifiers (SRI IDs) associated with a PUCCH Resource ID and corresponding SRI; and the determining module is configured to determine the PUCCH-SRI according to the PUCCH-SRI indication information, where the PUCCH-SRI indicates a PUCCH beam. In the embodiment of the present disclosure, a PUCCH-SRI indication mechanism can be provided, which can directly indicate the number of SRI IDs associated with the PUCCH Resource ID, reducing the situation that the terminal device can only indicate whether there is the second one of the SRI IDs associated with the PUCCH Resource ID, and the number of SRI IDs associated with the PUCCH Resource ID cannot be determined. This improves the accuracy and convenience of indicating the number of SRI IDs, thereby enhancing the accuracy of PUCCH beam determination. The present disclosure provides a processing apparatus for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

In some examples, in an embodiment of the present disclosure, the receiving module 1701, when receiving the PUCCH-SRI indication information sent by the network-side device, is specifically configured to: receive the PUCCH-SRI indication information sent by the network-side device, where the PUCCH-SRI indication information includes first information for indicating the number of SRI IDs associated with the PUCCH Resource ID, and a location of the first information is a location of one or more reserved bits in the indication information.

In some examples, in an embodiment of the present disclosure, a bit length of the first information is 2 bits.

In some examples, in an embodiment of the present disclosure, the receiving module 1701, when receiving the PUCCH-SRI indication information sent by the network-side device, is specifically configured to: receive the PUCCH-SRI indication information sent by the network-side device, where the PUCCH-SRI indication information includes second information and third information for indicating the number of SRI IDs associated with the PUCCH Resource ID, a location of the second information is a location of one or more non-reserved bits in the indication information, and a location of the third information is a location of one reserved bit in the indication information.

In some examples, in an embodiment of the present disclosure, the location of the third information includes one of: the location of the third information being a location of a first reserved bit in a row where the SRI ID0 is located; or the location of the third information being a location of a second reserved bit in a row where the SRI ID0 is located.

In some examples, in an embodiment of the present disclosure, the receiving module 1701, when receiving the PUCCH-SRI indication information sent by the network-side device, is specifically configured to: receive the PUCCH-SRI indication information sent by the network-side device, where the PUCCH-SRI indication information includes fourth information and fifth information, where the fourth information indicates whether there is a second one of the SRI IDs associated with the PUCCH Resource ID, and the fifth information indicates whether an SRI ID for a row corresponding to the fifth information is a last one of the SRI IDs associated with the PUCCH Resource ID.

In some examples, in an embodiment of the present disclosure, the location of the fifth information includes one of: the location of the fifth information being a location of a first reserved bit in a row where the fifth information is located; or the location of the fifth information being a location of a second reserved bit in a row where the fifth information is located.

FIG. 18 is a schematic structural diagram of a PUCCH-SRI indication system according to an embodiment of the present disclosure. As shown in FIG. 18, the system includes: a network-side device for performing the method as shown in any one of FIGS. 2 to 11; and a terminal device for performing the method as shown in any one of FIGS. 12 to 15.

To sum up, the present disclosure provides a processing system for the scenario of “PUCCH-SRI indication” to indicate the number of SRI IDs associated with the PUCCH Resource ID through PUCCH-SRI indication information, providing rules for indicating the number of SRI IDs. This can enhance the uplink transmission capabilities of the terminal device and improve the rate and reliability of data transmission.

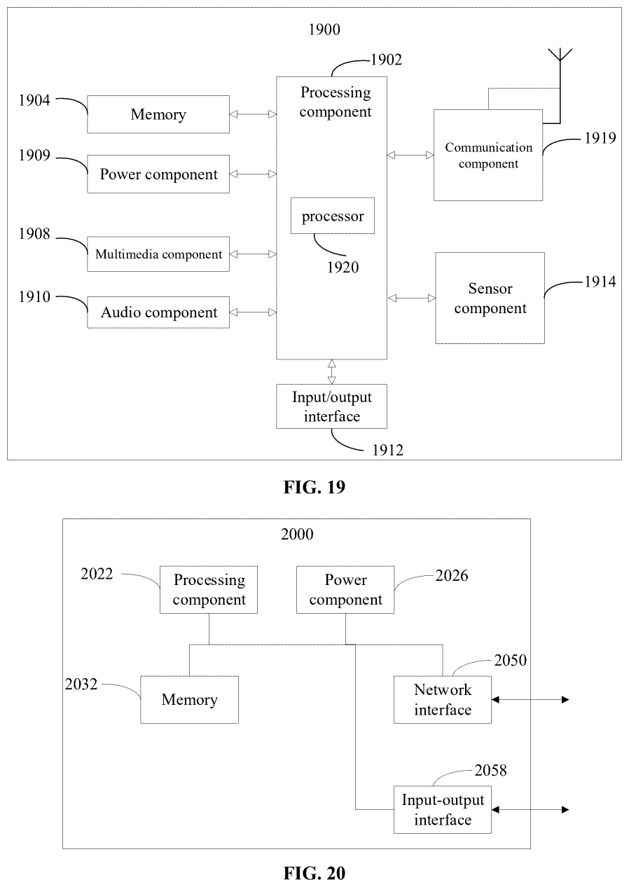

FIG. 19 is a block diagram of a terminal device UE1900 according to an embodiment of the present disclosure. For example, the UE1900 may be a mobile phone, a computer, a digital broadcasting terminal device, a messaging device, a game console, a tablet device, a medical device, a fitness device, a personal digital assistant, etc.

Referring to FIG. 19, the UE1900 may include at least one of the following components: a processing component 1902, a memory 1904, a power component 1909, a multimedia component 1908, an audio component 1910, an input/output (I/O) interface 1912, a sensor component 1914, and a communication component 1919.

The processing component 1902 generally controls the overall operation of the UE1900, such as operations associated with display, telephone call, data communication, camera operation and recording operation. The processing component 1902 may include at least one processor 1920 to execute instructions to complete all or part of steps of the above-mentioned method. In addition, the processing component 1902 may include at least one module to facilitate interactions between the processing component 1902 and other components. For example, the processing component 1902 may include a multimedia module to facilitate interactions between the multimedia component 1908 and the processing component 1902.

The memory 1904 is configured to store various types of data to support operations in the UE1900. Examples of these data include instructions of any application program or method for being operated on the apparatus UE1900, contact data, phone book data, messages, pictures, videos, etc. The memory 1904 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 1909 provides power to various components of the UE1900. The power component 1909 may include a power management system, at least one power supply, and other components associated with generating, managing and distributing power for the UE1900.

The multimedia component 1908 includes a screen that provides an output interface between the UE1900 and a user. In some embodiments, the screen may include a liquid crystal display (LCD) and a touch panel (TP). If the screen includes a touch panel, the screen may be implemented as a touch screen to receive an input signal from a user. The touch panel includes at least one touch sensor to sense touching, sliding and gestures on the touch panel. The touch sensor may not only sense a boundary of a touching or sliding action, but also detect a wake-up time and a pressure related to the touching or sliding operation. In some embodiments, the multimedia component 1908 includes a front camera and/or a rear camera. When the UE 1900 is in an operation mode, such as a shooting mode or a video mode, the front camera and/or the rear camera can receive external multimedia data. Each front camera and rear camera may be a fixed optical lens system or have focal length and optical zoom capability.

The audio component 1910 is configured to output and/or input audio signals. For example, the audio component 1910 includes a microphone (MIC) configured to receive external audio signals when the UE1900 is in the operation mode, such as a calling mode, a recording mode and a voice recognition mode. The received audio signal may be further stored in the memory 1904 or transmitted via the communication component 1919. In some embodiments, the audio component 1910 further includes a speaker for outputting audio signals.

The I/O interface 1912 provides an interface between the processing component 1902 and peripheral interface modules, where the peripheral interface modules may be keyboards, click-wheels, buttons, etc. These buttons may include, but are not limited to: home button, volume button, start button and lock button.

The sensor component 1914 includes at least one sensor for providing various aspects of state evaluation for the UE1900. For example, the sensor component 1914 can detect an on/off state of the UE1900, a relative positioning of components, for example, the components are the display and the keypad of the UE1900, and the sensor component 1914 can also detect a position change of the UE1900 or a component of the UE1900, presence or absence of user contact with the UE1900, orientation or acceleration/deceleration of the UE1900 and a temperature change of the UE1900. The sensor component 1914 may include a proximity sensor configured to detect presence of a nearby object without any physical contact. The sensor component 1914 may also include an optical sensor, such as a CMOS or CCD image sensor, for use in imaging applications. In some embodiments, the sensor component 1914 may further include an acceleration sensor, a gyroscope sensor, a magnetic sensor, a pressure sensor or a temperature sensor.

The communication component 1919 is configured to facilitate wired or wireless communication between the UE1900 and other devices. The UE1900 can access a wireless network based on communication standards, such as WiFi, 2G or 3G, or combinations thereof. In an embodiment, the communication component 1919 receives a broadcast signal or broadcast related information from an external broadcast management system via a broadcast channel. In an embodiment, the communication component 1919 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the UE1900 may be implemented by at least one application-specific integrated circuit (ASIC), digital signal processor (DSP), digital signal processing device (DSPD), programmable logic device (PLD), field programmable gate array (FPGA), controller, micro-controller, micro-processor or other electronic components, for executing the above-mentioned method.

FIG. 20 is a block diagram of a network-side device 2000 according to an embodiment of the present disclosure. For example, the network-side device 2000 can be provided as a network-side device. Referring to FIG. 20, the network-side device 2000 includes a processing component 2022, which further includes at least one processor, and memory resources represented by a memory 2032 for storing instructions that can be executed by the processing component 2022, such as application programs. An application program stored in the memory 2032 may include one or more modules each corresponding to a set of instructions. In addition, the processing component 2022 is configured to execute instructions to perform any of the aforementioned methods applied to the network-side device.

The network-side device 2000 may further include a power component 2026 configured to perform power management of the network-side device 2000, a wired or wireless network interface 2050 configured to connect the network-side device 2000 to a network, and an input-output (I/O) interface 2058. The network-side device 2000 can operate based on an operating system stored in the memory 2032, such as Windows Server™, Mac OS X™, Unix™, Linux™, Free BSD™, or the like.

In the above embodiments provided by the present disclosure, the methods provided by the embodiments of the present disclosure are introduced from the perspectives of a network-side device and a UE, respectively. In order to realize each of the functions in the method provided in the above embodiments of the present disclosure, the network-side device and the UE may include a hardware structure, a software module, and the above functions are realized in the form of hardware structure, software module, or hardware structure plus software module. One of the above functions can be implemented in a hardware structure, a software module, or a combination of hardware structure and software module.

In the above embodiments provided by the present disclosure, the methods provided by the embodiments of the present disclosure are introduced from the perspectives of a network-side device and a UE, respectively. In order to realize each of the functions in the method provided in the above embodiments of the present disclosure, the network-side device and the UE may include a hardware structure, a software module, and the above functions are realized in the form of hardware structure, software module, or hardware structure plus software module. One of the above functions can be implemented in a hardware structure, a software module, or a combination of hardware structure and software module.

A communication apparatus is provided by an embodiment of the present disclosure. The communication apparatus may include a transceiving module and a processing module. The transceiving module may include a sending module and/or a receiving module, where the sending module is configured to realize a sending function and the receiving module is configured to realize a receiving function, and the transceiving module may realize the sending function and/or the receiving function.

The communication apparatus may be a terminal device (such as the terminal device in the aforementioned method embodiment), an apparatus in the terminal device, or an apparatus that can be used in conjunction with the terminal device. Or, the communication apparatus may be a network device, an apparatus in a network device, or an apparatus that can be used in matching with the network device.

Another communication apparatus is provided by an embodiment of the present disclosure. The communication apparatus may be a network device, a terminal device (such as the terminal device in the aforementioned method embodiments), a chip, a chip system, or a processor that supports network device to implement the above method, or a chip, a chip system, or a processor that supports the terminal device to implement the above method. The apparatus can be configured to realize the methods described in the above-mentioned method embodiments, for details, please refer to the description in the above-mentioned method embodiments.

The communication apparatus may include one or more processors. The processor may be a general purpose processor or a specialized processor, etc. Such as a baseband processor or a central processing unit. The baseband processor can be configured to process communication protocols as well as communication data, and the central processor can be configured to control a communication apparatus (e.g., a network-side device, a baseband chip, a terminal device, a terminal device chip, a DU or a CU, etc.), execute a computer program, and process data from a computer program.

In some examples, the communication apparatus may further include one or more memories, on which a computer program may be stored, and the processor executes the computer program, so that the communication apparatus can execute the methods described in the above method embodiments. In some examples, data can also be stored in the memory. The communication apparatus and the memory may be set separately or integrated together.

In some examples, the communication apparatus may further include a transceiver and an antenna. The transceiver can be named as a transceiver unit, a transceiver machine, a transceiver circuit, etc., and is configured to realize transceiver functions. The transceiver may include a receiver and a transmitter, and the receiver may be named as a receiving machine or a receiving circuit, etc., and is configured to realize receiving functions. The transmitter may be named as a transmitting machine or a transmitting circuit, etc., and is configured to realize transmitting functions.

In some examples, the communication apparatus may further include one or more interface circuits. The interface circuit is configured to receive code instructions and transmit them to the processor. The processor executes the code instructions to cause the communication apparatus to perform the methods described in the above method embodiments.

The communication apparatus is a network-side device: the processor is configured to perform the method shown in any of FIGS. 2-11.

The communication apparatus is a terminal device (such as the terminal device in the aforementioned method embodiment): the processor is configured to perform the method shown in any of FIGS. 12-15.

In an implementation, the processor may include a transceiver for implementing receiving and transmitting functions. For example, the transceiver can be a transceiver circuit, an interface, or an interface circuit. The transceiver circuits, interfaces or interface circuits for receiving and transmitting functions can be separated or integrated. The transceiver circuit, interface or interface circuit can be configured to read and write codes/data, or the transceiver circuit, interface or interface circuit can be configured to signal transmission or delivery.

In an implementation, the processor can store a computer program, and the computer program runs on the processor, which can make the communication apparatus execute the methods described in the above-mentioned method embodiments. The computer program may be solidified in the processor, in which case, the processor may be implemented by hardware.

In an implementation, the communication apparatus may include a circuit, which may realize the function of transmitting or receiving or communicating in the above-mentioned method embodiments. The processor and transceiver described in the present disclosure can be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver can also be manufactured by various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS(BiCMOS), silicon germanium (SiGe), gallium arsenide (GaAs), etc.

The communication apparatus in the above description of embodiments may be a network device, or a terminal device (such as the terminal device in the previous method embodiments), but the scope of the communication apparatus described in the present disclosure is not limited thereto, and the structure of the communication apparatus may not be limited. The communication apparatus may be a stand-alone device or may be part of a larger device. For example, the communication apparatus may be: (1) a stand-alone integrated circuit IC, or chip, or system or subsystem of chips; (2) a collection with one or more ICs, in some examples, the collection of ICs may also include storage components for storing data, computer programs; (3) an ASIC, such as a modem; (4) a module that can be embedded in other devices; (5) a receiver, a terminal device, an intelligent terminal device, a cellular phone, a wireless device, handset, mobile unit, a vehicle-mounted device, a network device, a cloud device, an artificial intelligence device, etc.; and/or (6) others, etc.

For the case that the communication apparatus can be a chip or a chip system, the chip includes a processor and an interface. The number of processors may be one or more and the number of interfaces may be more than one.

In some examples, the chip further includes a memory for storing necessary computer programs and data.

Those skilled in the art can also understand that various illustrative logical blocks and steps listed in the embodiments of the present disclosure can be implemented by electronic hardware, computer software, or a combination of both. Whether such a function is realized in hardware or software depends on specific application and design requirements of an overall system. Those skilled in the art can use various methods to realize the described functions for each specific application, but this realization should not be understood as beyond the scope of protection of the embodiments of the present disclosure.

The present disclosure further provides a readable storage medium on which instructions are stored, which, when executed by a computer, realize the functions of any of the above method embodiments.

The present disclosure further provides a computer program product which, when executed by a computer, realizes the functions of any of the above method embodiments.

In the above embodiments, it can be realized in whole or in part by software, hardware, firmware or any combination thereof. When implemented using software, it may be implemented in whole or in part in the form of a computer program product. The computer program product includes one or more computer programs. When the computer program is loaded and executed on a computer, the flow or function according to the embodiments of the present disclosure is generated in whole or in part. The computer can be a general-purpose computer, a special-purpose computer, a computer network, or other programmable devices. The computer program can be stored in a computer-readable storage medium or transmitted from one computer-readable storage medium to another. For example, the computer program can be transmitted from a website, computer, server or data center to another website by wired (e.g., coaxial cable, optical fiber, digital subscriber line (DSL)) or wireless (e.g., infrared, wireless, microwave, etc.). The computer-readable storage medium may be any available medium that can be accessed by a computer or a data storage device such as a server, data center, etc. that contains one or more available media integrated. The available medium may be a magnetic medium (e.g., floppy disk, hard disk, magnetic tape), an optical medium (e.g., high-density digital video disc (DVD)), or a semiconductor medium (e.g., solid state disk (SSD)), etc.

A person of ordinary skill in the art may understand that “first, “second, and other various numerical numbers involved in the present disclosure are only described for the convenience of differentiation, and are not used to limit the scope of the embodiments of the present disclosure, nor do they indicate the order of precedence.

“At least one” in the present disclosure can further be described as one or more, and “a plurality” can be two, three, four or more, and the present disclosure is not limited. In the embodiment of the present disclosure, for a technical feature, the technical feature is distinguished by “first, “second, “third, “A, “B, “C” and “D” etc. The technical features described in “first, “second, “third, “A, “B, “C” and “D” are in no order of priority or size.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. A method for physical uplink control channel-spatial relationship information (PUCCH-SRI) indication, performed by a network-side device, the method comprising:
sending PUCCH-SRI indication information to a terminal device, wherein the PUCCH-SRI indication information indicates a number of spatial relationship information identifiers (SRI IDs) associated with a PUCCH Resource ID and corresponding SRI.

2. The method according to claim 1, wherein the sending PUCCH-SRI indication information to the terminal device comprises:
sending medium access control control element (MAC CE) signaling to the terminal device, wherein the MAC CE signaling comprises the PUCCH-SRI indication information.

3. The method according to claim 2, further comprising:
determining, according to an extend logical channel identifier (eLCID) in a MAC subheader, the SRI carried in the MAC CE signaling.

4. The method according to claim 1, wherein
the PUCCH-SRI indication information comprises first information for indicating the number of SRI IDs associated with the PUCCH Resource ID, and a location of the first information is a location of one or more reserved bits in the indication information.

5. The method according to claim 4, wherein a bit length of the first information is 2 bits.

6. The method according to claim 1, wherein
the PUCCH-SRI indication information comprises second information and third information for indicating the number of SRI IDs associated with the PUCCH Resource ID, a location of the second information is a location of one or more non-reserved bits in the indication information, and a location of the third information is a location of one reserved bit in the indication information.

7. The method according to claim 6, wherein
the location of the third information is a location of a first reserved bit in a row where the SRI ID0 is located; or
the location of the third information is a location of a second reserved bit in a row where the SRI ID0 is located.

8. The method according to claim 1, wherein
the PUCCH-SRI indication information comprises fourth information and fifth information, wherein the fourth information indicates whether there is a second one of the SRI IDs associated with the PUCCH Resource ID, and the fifth information indicates whether an SRI ID for a row corresponding to the fifth information is a last one of the SRI IDs associated with the PUCCH Resource ID.

9. The method according to claim 8, wherein
a location of the fifth information is a location of a first reserved bit in a row where the fifth information is located; or
a location of the fifth information is a location of a second reserved bit in a row where the fifth information is located.

10. A method for physical uplink control channel-spatial relationship information (PUCCH-SRI) indication, performed by a terminal device, the method comprising:
receiving PUCCH-SRI indication information sent by a network-side device, wherein the PUCCH-SRI indication information indicates a number of spatial relationship information identifiers (SRI IDs) associated with a PUCCH Resource ID and corresponding SRI; and
determining PUCCH-SRI according to the PUCCH-SRI indication information, wherein the PUCCH-SRI indicates a PUCCH beam.

11. The method according to claim 10, wherein
the PUCCH-SRI indication information comprises first information for indicating the number of SRI IDs associated with the PUCCH Resource ID, and a location of the first information is a location of one or more reserved bits in the indication information.

12. The method according to claim 11, wherein a bit length of the first information is 2 bits.

13. The method according to claim 10, wherein
the PUCCH-SRI indication information comprises second information and third information for indicating the number of SRI IDs associated with the PUCCH Resource ID, a location of the second information is a location of one or more non-reserved bits in the indication information, and a location of the third information is a location of one reserved bit in the indication information.

14. The method according to claim 13, wherein
the location of the third information is a location of a first reserved bit in a row where the SRI ID0 is located; or
the location of the third information is a location of a second reserved bit in a row where the SRI ID0 is located.

15. The method according to claim 10, wherein
the PUCCH-SRI indication information comprises fourth information and fifth information, wherein the fourth information indicates whether there is a second one of the SRI IDs associated with the PUCCH Resource ID, and the fifth information indicates whether an SRI ID for a row corresponding to the fifth information is a last one of the SRI IDs associated with the PUCCH Resource ID.

16. The method according to claim 15, wherein
a location of the fifth information is a location of a first reserved bit in a row where the fifth information is located; or
a location of the fifth information is a location of a second reserved bit in a row where the fifth information is located.

17.-18. (canceled)

19. A network-side device, comprising:
a processor; and
a memory storing a computer program, and
wherein the computer program when executed by the processor causes the network-side device to:
send physical uplink control channel-spatial relationship information (PUCCH-SRI) indication information to a terminal device, wherein the PUCCH-SRI indication information indicates a number of spatial relationship information identifiers (SRI IDs) associated with a PUCCH Resource ID and corresponding SRI.

20. A communication device, comprising:
a processor; and
a memory that stores a computer program, and
the computer program when executed by the-processor causes the communication device to act as the terminal device and perform the method according to claim 10.

21. (canceled)

22. A non-transitory computer-readable storage medium storing instructions, the instructions when executed by a processor of the network-side device, cause the network-side device to perform the method according to claim 1.

23. A physical uplink control channel-spatial relationship information (PUCCH-SRI) indication system, comprising:
the network-side device for performing the method according to claim 1; and
the terminal device, wherein the terminal device is configured to:
receive PUCCH-SRI indication information sent by the network-side device, wherein the PUCCH-SRI indication information indicates a number of spatial relationship information identifiers (SRI IDs) associated with a PUCCH Resource ID and corresponding SRI; and
determine PUCCH-SRI according to the PUCCH-SRI indication information, wherein the PUCCH-SRI indicates a PUCCH beam.
